(19) United States
(12) Patent Application Publication
(10) Pub. No.: US 2013/0123086 A1
(43) Pub. Date: May 16, 2013

(54) METHOD AND A MACHINE FOR PRODUCING A CONTAINER, IN PARTICULAR A CONTAINER FOR POURABLE FOOD PRODUCTS

(71) Applicant: Paolo Benedetti, Modena (IT)

(72) Inventor: Paolo Benedetti, Modena (IT)

(73) Assignee: TETRA LAVAL HOLDINGS & FINANCE S.A., Pully (CH)

(21) Appl. No.: 13/812,710

(22) PCT Filed: Aug. 23, 2011
(86) PCT No.: PCT/EP2011/064455

§ 371 Date: Jan. 28, 2013

(30) Foreign Application Priority Data
Sep. 14, 2010 (EP) 10176717.6

(51) Int. Cl. B31C 1/00; B31C 1/02

(52) U.S. Cl. CPC B31C 1/00; B31C 1/02
USPC 493/297; 493/269

(57) ABSTRACT

A method for producing a container comprising a sleeve-like main portion and an end piece attached to the main portion; the method comprises the steps of: advancing, along a given path, at least one forming member having an axis transversal to the path, and delimited by a top surface and by a lateral surface extending around said axis; feeding the end piece on the top surface of the forming member; wrapping a sheet of packaging material around the lateral surface of the forming member such that the opposite side edges of the sheet parallel to the axis overlap one another; joining the overlapped edges of the sheet by a longitudinal seal so as to form the sleeve-like main portion of the container; and joining a peripheral edge of the end piece to an upper end of the sleeve-like main portion by a transversal seal extending around the axis.

### TECHNICAL FIELD

The present invention relates to a method and a machine for producing a container, in particular a container for pourable food products.

### BACKGROUND ART

As it is known, many pourable food products, such as fruit juice, milk, tomato sauce and beverages in general, are sold in a wide range of containers of different types and sizes, such as: containers made of multilayer, plastic- and/or paper-based, laminated materials or so-called multilayer cardboard materials; beaker-shaped plastic containers; blow-molded bottles; or glass, sheet metal or aluminium containers.

All these containers are fitted with opening devices for allowing access by the consumer to the food product, either to pour it into a drinking vessel or to consume it straight from the container.

Screw cap opening devices are commonly used on bottle-type containers, whereas containers made of multilayer cardboard materials, briefly referred to as “cartons” hereafter, are often simply provided with tear-off markers, or with pour openings formed in the containers and covered with pull tabs.

Containers made of multilayer cardboard materials are also known to be fitted with plastic opening devices injection molded directly onto the containers, about openings formed through the packaging material, so as to completely close and seal the openings. Opening devices of this sort normally define the pour opening of the container, which may be fitted, for example, with a screw or snap cap.

Injection molded opening devices may of course be of various sizes and even define the whole top portion of the container, as in the case of the container known by the registered trademark “Tetra Top”.

As described, for example in Patent EP-B-1197438, plastic top portions of containers are also known to be produced by blowing a plastic tubular preform.

The container known by the trademark “Tetra Aptiva” is one example of a composite container produced using this technique, i.e. having a main portion made of multilayer cardboard material, and a top portion, for pouring the liquid or pourable product in the container, produced by blowing a plastic tubular preform.

Another example of a plastic top portion for this type of composite containers is illustrated in international patent application No. WO2008/148764.

In this case, the plastic top portion can be obtained not only by blowing a plastic tubular preform but also by thermoforming or by other suitable techniques, such as compression molding.

A need is particularly felt within the packaging industry to find a quick, rational, reliable and economical way to produce this kind of composite containers.

### DISCLOSURE OF INVENTION

It is an object of the present invention to provide a method and a machine for producing a container, which is designed to meet the above-identified need.

This object is achieved by a method as claimed in claim 1 and by a machine as claimed in claim 10.

The present invention also relates to a method and a machine for producing a sleeve-like element of a multilayer packaging material, as claimed in claims 20 and 21, respectively.

### BRIEF DESCRIPTION OF THE DRAWINGS

A preferred, non-limiting embodiment of the present invention will be described by way of example with reference to the accompanying drawings, in which:

FIG. 1 schematically shows the way in which a semifinished composite container is obtained through the method according to the teachings of the present invention;

FIG. 2 shows a side view of a finished composite container which can be obtained from the FIG. 1 semifinished container;

FIG. 3 shows a bottom view of the FIG. 2 container;

FIG. 4 shows a front view of the FIG. 2 container;

FIG. 5 shows an exploded front view of the FIG. 4 container;

FIG. 6 shows a view in perspective, with parts removed for clarity, of a machine in accordance with the teachings of the present invention for producing the FIG. 1 semifinished composite container;

FIG. 7 shows a larger-scale section, along a vertical section plane and with parts removed for clarity, of an operating unit of the FIG. 6 machine;

FIG. 8 shows a larger-scale view in perspective, with parts removed for clarity, of a cam device for controlling movement of the FIG. 7 operating unit;

FIG. 9 shows a larger-scale view in perspective, with parts removed for clarity, of a detail of the FIG. 6 machine; and

FIG. 10 shows a larger-scale view in perspective, with parts removed for clarity, of another detail of the FIG. 6 machine.

### BEST MODE FOR CARRYING OUT THE INVENTION

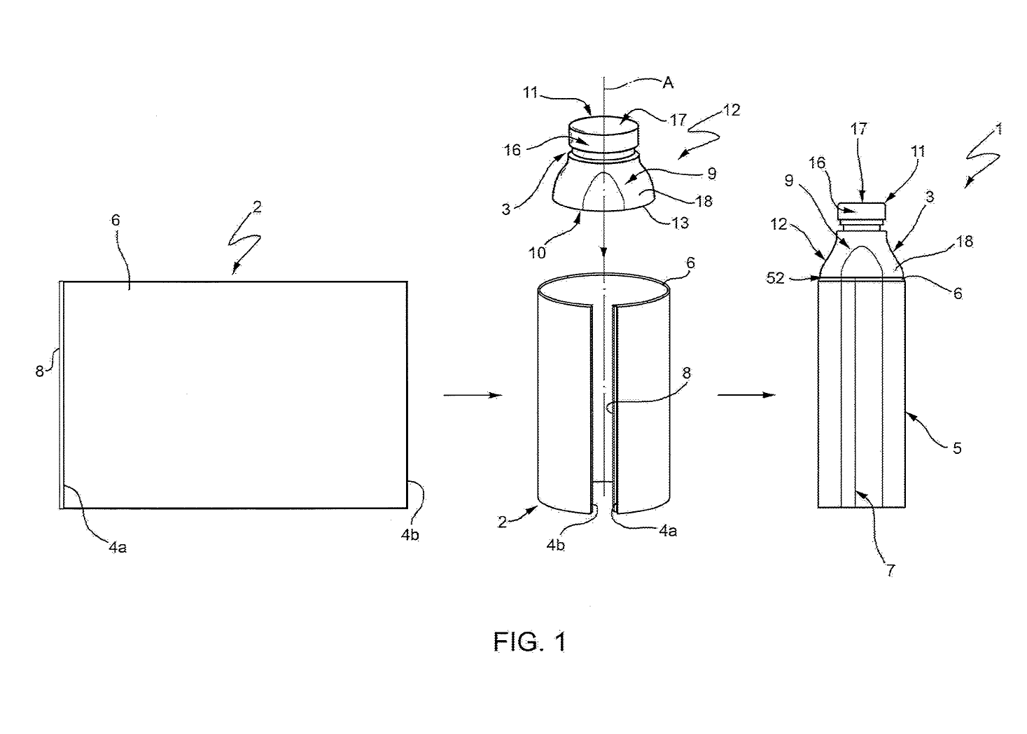

Number 1 in FIG. 1 indicates as a whole a semifinished composite container for pourable food products, which is obtained through the method according to the present invention starting from a rectangular or square sheet 2 of multilayer packaging material and a pouring part 3 made of plastic material.

The multilayer packaging material of sheet 2 comprises a layer of fibrous material, e.g. paper, or of mineral-filled polypropylene material; a number of layers of heat-seal plastic material, e.g. polyethylene film; and a layer of gas- and light-barrier material, e.g. aluminium or ethyl vinyl alcohol (EVOH).

As explained in more detail later on, container 1 is obtained by folding and sealing the sheet 2 to form a sleeve-like main portion 5 of axis A and by coaxially attaching the pouring part 3 to an upper end 6 of the main portion 5.

In particular, the sheet 2 is folded so as to take a tubular or sleeve-like configuration and to overlap its opposite side edges 4a, 4b; the sheet 2 is then sealed along the overlapped edges 4a, 4b to form a longitudinal seal 7.

As visible in FIG. 1, edge 4a of sheet 2 is further provided with a sealing strip 8 made of heat-seal plastic material and which, in the sleeve-like configuration, is sealed on the inner faces of both edges 4a, 4b for preventing such edges from absorbing in use the food product and for improving the gas-barrier performance and physical strength of longitudinal seal 7.

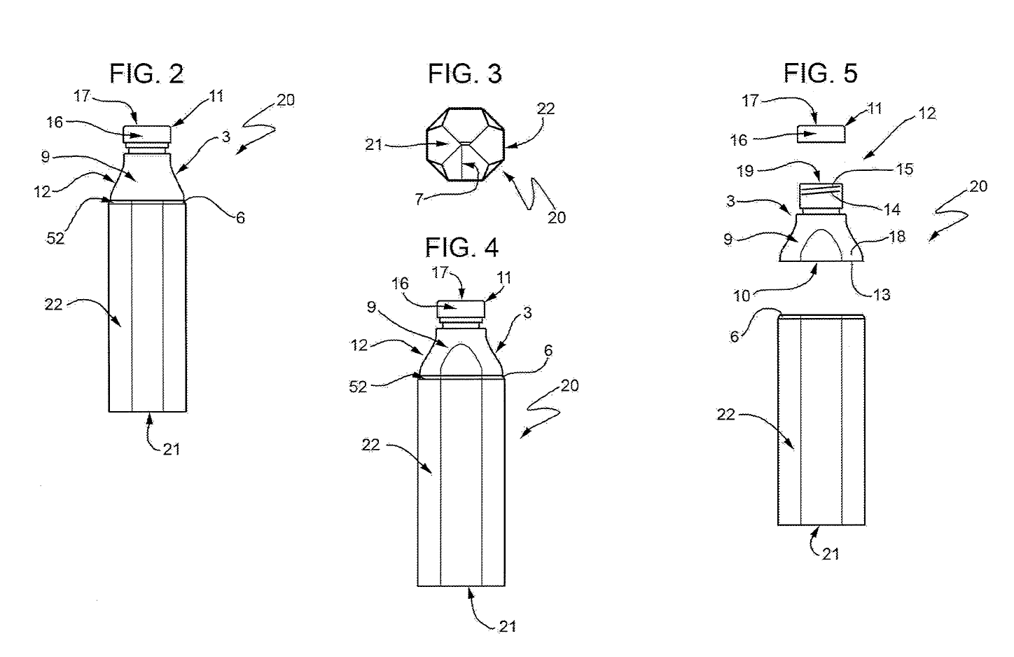

As shown in FIGS. 1 to 5, pouring part 3 basically comprises a pouring spout or neck 9, defining in use a pour opening 10 by which to pour the food product, and a cylindrical cap 11 fitted to the neck 9 in a removable way.

Pouring part 3 may include a gas- and/or light-barrier and integrally defines a complete top portion 12 of container 1.

Top portion 12 is produced, and attached to the main portion 5, in a closed configuration. An example of this kind of top portion is disclosed in WO 2008/148764.

Advantageously, neck 9 of top portion 12 has an inverted-cup shape and comprises an annular side wall 18 laterally bounding pour opening 10 and a disk-shaped top wall 19 closing pour opening on the side in which cap 11 is fitted to the neck 9 itself.

In particular, side wall 18 of neck 9 has a bottom peripheral edge 13 adapted to be attached to upper end 6 of main portion 5 and a top end portion 14 provided with a thread 15 on its outer side surface.

Cap 11 is produced in a single piece and is substantially defined by an annular cylindrical side wall 16, which has an internal thread (not visible in the enclosed Figures) for engaging the corresponding thread 15 of side wall 18 of neck 9, and by a disk-shaped top wall 17 for closing, in use, the top of the neck 9.

Cap 11 is initially screwed completely onto neck 9 so that Lop wall 17 is superimposed on Lop wall 19 of neck 9. As explained in WO 2008/148764, neck 9 has a weakening line (not visible in the enclosed Figures) between side wall 18 and top wall 19, and cap 11 is provided with means (also not visible in the enclosed Figures) for producing detachment of the top wall 19 from the side wall 18 upon removal of the cap 11 from the neck 9.

As a possible alternative not shown, neck 9 may be also produced in a completely open configuration (i.e. without top wall 19) and closed by cap 11.

In both cases, semifinished container 1 can be transformed in a finished container 20 by further not disclosed operations, including a filling operation to fill the container 1 with the pourable food product, a folding and sealing operation to form a flat bottom wall 21 orthogonal to axis A, and further folding operations to give the final appearance to main portion 5, which, in the example shown, comprises a side wall 22 having, in a bottom view (please see in particular FIG. 3), an octagonal perimeter.

Advantageously, the filling operation is performed on container 1 by introducing the product from the bottom side thereof, i.e. from the side opposite cap 11, before bottom wall 21 is formed and sealed.

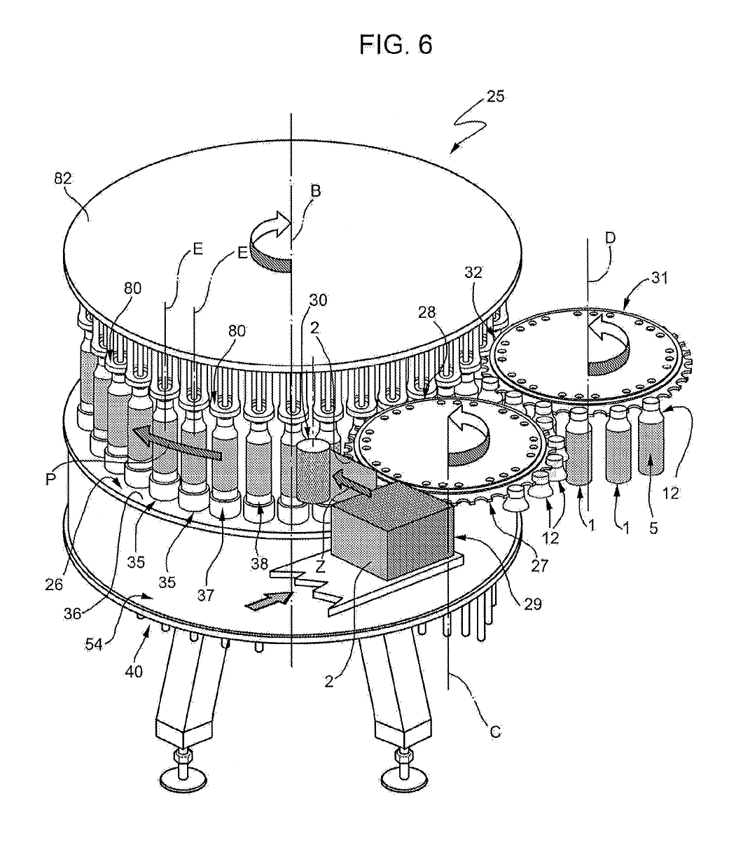

Semifinished composite container 1 is produced on a packaging machine 25 shown in FIG. 6 and made in accordance with the teachings of the present invention.

Machine 25 comprises a conveying device that serves to fold and seal a plurality of sheets 2 in the sleeve-like configuration and to produce attachment of a plurality of top portions 12 to the relative plurality of sheets 2.

In the preferred embodiment as illustrated in the FIGS. 6, 9 and 10, the conveying device comprises a carousel 26, which is mounted to rotate continuously (clockwise in FIG. 6) about a respective vertical axis B.

The carousel 26 receives a succession of top portions 12 from an input wheel 27, which cooperates with carousel 26 at a transfer station 28 and is mounted to rotate about a respective longitudinal axis C parallel to axis B. The rotation of the input wheel 27 is continuous and synchronized with the rotation of carousel 26.

The carousel 26 also receives a succession of sheets 2 from an input device 29 (only schematically shown), which cooperates with carousel 26 at a transfer station 30; in particular, the sheets 2 are fed to the carousel 26 with their side edges 4a, 4b parallel to axis B and along a direction Z transversal to such axis.

The carousel 26 releases a succession of semifinished containers 1 to an output wheel 31, which cooperates with carousel 26 at a transfer station 32 and is mounted to rotate about a respective longitudinal axis D parallel to axes B and C. The rotation of the output wheel 31 is continuous and synchronized with the rotation of carousel 26.

The carousel 26 comprises a plurality of operating units 35, which are equally spaced about axis B, are mounted along a peripheral edge of carousel 26, and are moved by carousel 26 along a circular path P extending about axis B and through transfer stations 28, 30 and 32. As shown in FIG. 6, transfer station 30 is arranged, along path P, downstream of transfer station 28 and upstream of transfer station 32.

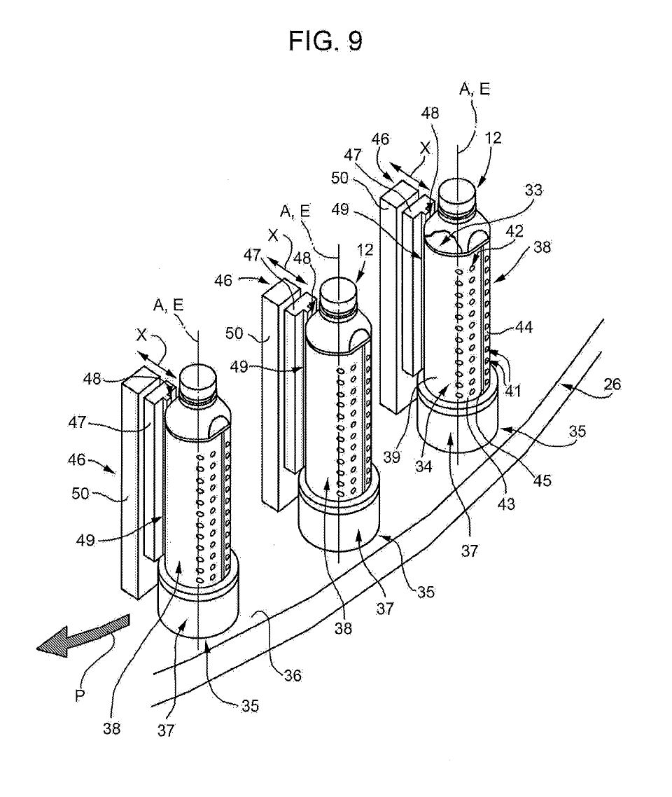

With reference to FIGS. 6 and 9, the operating units 35 are secured to a horizontal rotary table 36 of carousel 26, have respective axes E parallel to axes B, C, D and extend coaxially through respective holes (not shown) of the rotary table 36 and on both sides of such table.

Operating units 35 being identical to each other, only one is described below for the sake of simplicity and clarity; it is clear that the features described hereafter are common to all the operating units 35.

With reference to FIGS. 6 to 10, operating unit 35 comprises:
a hollow supporting mount 37, which extends along axis E and is secured to rotary table 36 around the relative hole thereof; and
a hollow forming member 38, engaging the supporting mount 37 in sliding and rotating manner with respect to axis E, having a top surface 33 adapted to support and engage coaxially a relative top portion 12 and comprising a substantially cylindrical side wall 39 adapted to carry a relative sheet 2 on its outer surface 34.

Forming member 38 can be moved along axis E by means of a cam and tappet device 40 (which will be described later in greater detail) to take a lowered position, a raised position and an intermediate position.

In the lowered position, forming member 38 is completely retracted within supporting mount 37, so that top surface 33 is substantially flush with a top surface of the supporting mount 37. In the intermediate position, forming member 38 protrudes from the top surface of the supporting mount 37 by a given value and is adapted to receive, on the outer surface 34 of its side wall 39, a sheet 2 from the input device 29. In the raised position, forming member 38 protrudes from the top surface of supporting mount 37 by a greater value than in the intermediate position.

More specifically, with reference to FIG. 6, sheets 2 are cut in a know manner from a web (not shown) by a cutting device (known per se and not shown) and fed to the input device 29, which in turn feeds the sheets 2 to the carousel 26 with the respective sealing strips 8 arranged in a forward position. As mentioned above, sheets 2 are fed by the input device 29, respectively, onto the outer surfaces 34 of the side walls 39 of the forming members 38, while the latter are located in the intermediate position.

As shown in FIG. 9, side wall 39 of each forming member 38 is provided with a plurality of through holes 41, in turn connected to a pneumatic suction device (known per se and not shown), so as to retain the relative sheet 2 on its outer surface 34 by suction.

At the transfer station 30, each forming member 38 is rotated about the relative axis E in order to produce the complete wrapping of the relative sheet 2, coming from input device 29, on its outer surface 34. The rotation of the forming members 38 can be performed either in the same direction as the direction of rotation of carousel 26 about axis B (clockwise direction) or in the opposite direction (counter-clockwise direction).

In particular, each sheet 2, fed by input device 29, is wrapped around the relative forming member 38 so as to form a cylinder with the vertical edge 4a superimposed on the vertical edge 4b, which is in turn interposed between the vertical edge 4a and part of the sealing strip 8.

More specifically, holes 41 extend only on a given portion 42, hereafter referred to as “suction portion”, of side wall 39. Suction portion 42 has an arc-shaped cross section along a plane orthogonal to axis E and is sized in the circumferential direction so as to cooperate with two portions of the relative sheet 2, which are adjacent, respectively, to the vertical edges 4a, 4b.

In greater detail, suction portion 42 is divided into two distinct vertical regions 43, 44 by an elastically deformable, vertical strip pad 45, on which vertical edges 4a, 4b and sealing strip 8 of a relative sheet 2 are placed in an overlapped configuration.

Strip pad 45 defines, in a known manner, the contrasting element for a relative sealing device 46 (only schematically shown in FIG. 9), arranged in front of, and in a radially inner position than, side wall 39 of the relative forming member 38 and adapted to seal the overlapped edges 4a, 4b and the sealing strip 8 of the relative sheet 2 so as to produce a tubular configuration of such sheet.

In particular, each sealing device 46 is carried in an upright position by the rotating table 36 and comprises:
a sealing element 47 provided with a rectilinear striplike active working surface 48 having a height at least equal to the height of the overlapped edges 4a, 4b and the sealing strip 8 to be sealed; and
an actuator assembly 50 for moving sealing element 47 to and from the relative overlapped edges 4a, 4b and the sealing strip 8 along a direction X transversal to path P and axis E of the relative forming member 38.

In the example shown, the sealing operation is carried out by electromagnetic induction; in practice, an electric current is induced in the barrier layer of the processed sheet 2 to heat it locally and so locally melt the heat-seal plastic material in the region to be sealed.

The sealing element 47 of each sealing device 46 includes an inductor 49, which defines the rectilinear striplike active working surface 48 and is supplied by a high-frequency current generator (known per se and not shown); by activating inductor 49, a longitudinal seal 7 is produced on the relative sheet 2 along edges 4a, 4b and sealing strip 8 so that the sheet 2 is transformed into the sleeve-like main portion 5 of a relative semifinished container 1.

As a possible alternative not shown, in cases in which the multilayer packaging material lacks an electrically conductive layer, the sealing operation may be carried out by simply heating a sealing element adapted to cooperate with the region of the sheet 2 to be sealed.

As a further possible alternative not shown, the sealing operation may be carried out by using an ultrasonic sealing device.

In the light of the above, each forming member 38, during travel of the relative operating unit 35 along path P, is subjected to distinct movements in different operative steps of the packaging machine 25:
a displacement along axis E from the lowered position to the intermediate position in order to be fed with a relative top portion 12;
a rotation about axis E to receive a relative sheet 2 from input device 29 and to allow folding of such sheet 2 in the tubular configuration;
a displacement from the intermediate position to the raised position, in which a sealing operation, described in greater detail later on, is performed to produce a circumferential, transversal seal 52 between the upper end 6 of the sleeve-like main portion 5 obtained from sheet 2 and the relative top portion 12; and
a displacement from the raised position to the lowered position to allow extraction of the so formed semifinished container 1 from operating unit 35.

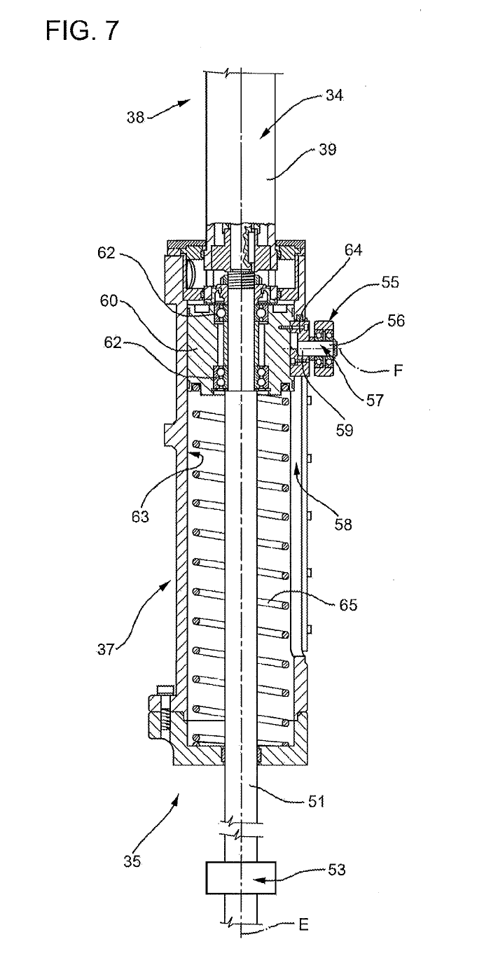

With reference to FIG. 7, these movements are obtained by means of a driving shaft 51, which is coaxial with the relative forming member 38, extends through the relative supporting mount 37 and has a top end coupled in a fixed position to a bottom end of such forming member 38. Therefore, each driving shaft 51 and the relative so forming member 38 are axially and angularly fixed to one another, so that any displacement transmitted to the driving shaft 51 results in a corresponding displacement of the forming member 38.

Rotation of each driving shaft 51 is synchronized with the feeding movements imparted to the sheets 2 by the input device 29 and with the rotation of the carousel 26 and is operated by an actuator 53 (schematically shown in FIG. 7), which is carried by the carousel 26 itself.

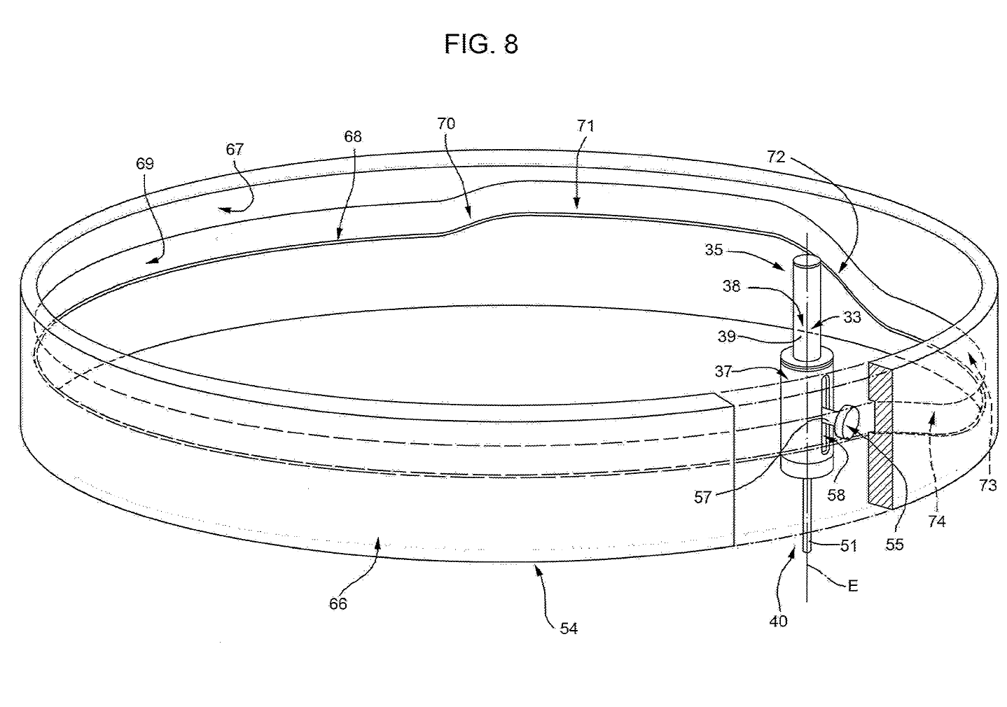

Vertical displacement of each driving shaft 51 is operated by the cam and tappet device 40 independently from the rotation operated by the relative actuator 53. The cam and tappet device 40 comprises a cam device 54 (FIG. 8) and, for each operating unit 35, a relative cam follower 55, which is defined, in particular, by a roller located outside of the relative supporting mount 37 and mounted on an outer end portion 56 of a supporting pin 57, so as to be axially fixed and freely rotatable with respect to an axis F of the supporting pin 57. The latter extends radially with respect to axes B and E through a slot 58, which is made in a lateral wall of the relative supporting mount 37 on the outer side with respect to axis B, i.e. on the side opposite to the relative sealing device 46. The supporting pin 57 has an end portion 59 axially opposite to end portion 56 and fixed with respect to a collar 60. Collar 60 is coaxial with the relative driving shaft 51 and is coupled to the driving shaft 51 by means of bearings 62, so as to be angularly free from, and axially fixed with respect to, the driving shaft 51 itself. Besides, collar 60 has an outer lateral surface slidably coupled to the inner surface 63 of the relative supporting mount 37, so as to be axially guided between an upper position and a lower position.

In particular, end portion 59 is coupled to collar 60 by means of an annular element 64, which is fastened to the relative supporting pin 57 and to a side portion of the relative collar 60, and is guided by the relative slot 58 in a direction parallel to axis E. Therefore, the slot 58 defines a constraint that prevents the collar 60 and the cam follower 55 from rotating about axis E. Therefore, any displacement transmitted to a cam follower results in an axial displacement of the relative driving shaft 51 and forming member 38 between the lowered and raised positions. Preferably, a spring 65 is provided inside each supporting mount 37 to push the relative collar 60 upwards and, therefore, avoid axial play during displacement of the relative cam follower 55.

With reference to FIG. 8, the cam device 54 comprises a cylindrical ring element 66, which is fixed and extends coaxially with axis B and along path P around the operating units 35 that are transferred by carousel 26.

Ring element 66 has, on its radially inner surface 67, an annular groove or track 68 which is engaged by the cam followers 55 of operating units 35.

Starting from transfer station 28 and proceeding along path P, track 68 comprises:
a first horizontal arc-shaped portion 69 of about 180° lying on a plane perpendicular to axis B and adapted to maintain the engaging cam followers 55 at a height corresponding to the intermediate position of the respective forming members 38;
a rising ramp-shaped portion 70 for lifting the engaging cam followers 55 to a height corresponding to the raised position of the respective forming members 38;
a second horizontal arc-shaped portion 71 of about 60°-70° lying on a plane perpendicular to axis B and adapted to maintain the engaging cam followers 55 at the height corresponding to the raised position of the respective forming members 38;
a descending ramp-shaped portion 72 for lowering the engaging cam followers 55 to a height corresponding to the lowered position of the respective forming members 38;
a third horizontal arc-shaped portion 73 of about 40°-50° lying on a plane perpendicular to axis B and adapted to maintain the engaging cam followers 55 at the height corresponding to the lowered position of the respective forming members 38; and
a rising ramp-shaped portion 74 for lifting the engaging cam followers 55 to a height corresponding to the intermediate position of the respective forming members 38.

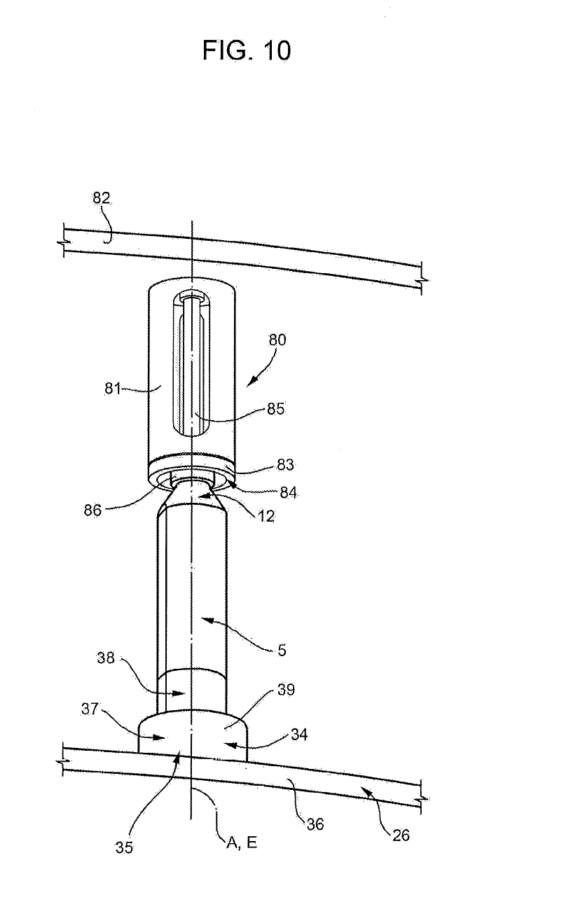

With reference to FIGS. 6 and 10, machine 25 also comprises, for each operating unit 35, a further sealing device 80 for sealing the upper end 6 of the sleeve-like main portion 5 obtained from the relative sheet 2 to the peripheral edge 13 of the corresponding top portion 12.

Each sealing device 80 basically comprises a substantially cylindrical casing 81 of axis E, protruding vertically from an upper rotary portion 82 of carousel 26, and an annular inductor 83 secured to the bottom end of casing 81 and supplied by a high-frequency current generator (known per se and not shown).

The inductor 83 defines an annular striplike active working surface 84 interacting with the upper end 6 of the relative sleeve-like main portion 5 and the peripheral edge 13 of the corresponding top portion 12, when the relative forming member 38 is arranged in the raised position.

Each sealing device 80 further comprises a positioning bar 85 coaxially housed within casing 81 and having a bottom tubular end 86 adapted to be engaged by cap 11 of the relative top portion 12.

The sealing of a top portion 12 to the corresponding sleeve-like main portion 5 is obtained by displacing the relative forming member 38 to the raised position so that the cap 11 is received into the bottom tubular end 86 of the relative positioning bar 85 and the relative working surface 84 contacts the upper end 6 of the main portion 5; in this way, pressure is created and the sealing is performed by activating the inductor 83, which induces an electric current in the barrier layer of the sheet 2 so as to heat and locally melt the upper end 6 of the sheet 2 itself and the peripheral edge 13 of the top portion 12; in practice, by activating inductor 83, a circumferential, transversal seal 52 of axis E is produced between the sleeve-like main portion 5 and the corresponding top portion 12 so as to obtain the semifinished container 1.

As a possible alternative not shown, in cases in which the multilayer packaging material lacks an electrically conductive layer, the sealing operation may be carried out by simply heating an annular sealing element adapted to interact with the upper end 6 of the sleeve-like main portion 5 obtained by a relative sheet 2 and to produce sealing of such end with the peripheral edge 13 of the corresponding top portion 12.

As a further possible alternative not shown, the sealing operation may be carried out by using an ultrasonic sealing device.

Operation of packaging machine 25 will now be described with reference to the production of one semifinished container 1, and therefore to one operating unit 35, as of the instant in which (FIG. 6):
the forming member 38 has just crossed transfer station 28 and is in the intermediate position with the corresponding cam follower 55 engaging portion 69 of track 68 of cam device 54;
one top portion 12 has been already fed onto the top surface 33 of the forming member 38 by input wheel 27; and
the relative sealing element 47 is spaced from the forming member 38 along the relative direction X.

At the transfer station 30, one sheet 2 is put into contact with the forming member 38 passing through such station by the input device 29; in particular, the sheet 2 is advanced towards the forming member 38 with its side edge 4a and its sealing strip 8 facing forward.

Thanks to the rotation of forming member 38 around its axis E and the activation of the suction through holed 41, the sheet 2 is wrapped around the outer surface of lateral wall 39 of the forming member 38 and retained thereon. More specifically, the sheet 2 is bent to assume a tubular configuration with the opposite vertical edges 4a, 4b and the sealing strip 8 in overlapped configuration.

In the example shown, due to the fact that the top portion 12 is fed to the forming member 38 before the sheet 2, the upper end 6 thereof overlaps the peripheral edge 13 of the top portion 12.

At this point, the sheet 2 is ready to be sealed along the edges 4a, 4b and the sealing strip 8 by activation of the sealing device 46.

In particular, the forming member 38 reaches a given angular position around its axis E so as to put the overlapped edges 4a, 4b and the sealing strip 8 of the sheet 2 in front of the working surface 48 of the sealing device 46. The sealing element 47 can then be displaced by the actuator 50 along direction X into a position, in which the working surface 48 contacts the outer edge 4a of the sheet 2.

By activating inductor 49 of sealing element 47, an electric current is induced in the barrier layer of the sheet 2 to heat it in the region of the overlapped edges 4a, 4b and the sealing strip 8 and so locally melt the heat-seal plastic material thereof to obtain longitudinal seal 7.

In this way, the sheet 2 is transformed into the sleeve-like main portion 5 of the semifinished container 1.

At this point, the sealing element 47 is displaced to its beginning position along direction X, so detaching the working surface 48 from the main portion 5.

During the subsequent movement of the operating unit 35 along path P, rising ramp-shaped portion 70 of track 68 of cam device 54 moves the driving shaft 51 along axis F, so producing a corresponding translational movement of the forming member 38 towards the raised position. This movement causes engagement of top portion 12 into sealing device 80; in particular, cap 11 of top portion 12 is pressed against positioning bar 85 and the upper end 6 of main portion 5, superimposed on peripheral edge 13 of the top portion 12, is pressed against active working surface 84 of inductor 83.

In a completely analogous manner to what occurs with sealing device 46, by activating inductor 49, an electric current is induced in the barrier layer of the sheet 2 to heat it in the region overlapped to the peripheral edge 13 of top portion 12 and so locally melt the heat-seal plastic materials into contact with one another to obtain circumferential, transversal seal 52.

During the subsequent part of the path P, descending ramp-shaped portion 72 of track 68 of cam device 54 causes the forming member 38 to be displaced into the lowered position within the relative supporting mount 37, so as to free the so formed semifinished composite container 1, which can be then released to the output wheel 31 at transfer station 32.

During the last part of the path P, the forming member 38 is then moved into the intermediate position as a result of engagement between the cam follower 55 and rising ramp-shaped portion 74 of track 68 of cam device 54; the forming member 38 is therefore ready to receive another top portion 12 and another sheet 2.

In the light of the above, the method and the machine 25 according to the present invention permit to produce, in a quick, rational, reliable and economical way, a composite container.

Clearly, changes may be made to the method and machine as described and illustrated herein without, however, departing from the scope as defined in the accompanying claims.

1. A method for producing a container comprising a sleeve-like main portion and an end piece attached to said main portion, said method comprising:
advancing, along a given path, at least one forming member having an axis transversal to said path, and delimited by a top surface and by a lateral surface extending around said axis;
feeding said end piece on said top surface of said forming member;
wrapping a sheet of packaging material around said lateral surface of said forming member such that the opposite side edges of the sheet parallel to said axis overlap one another;
joining said overlapped edges of said sheet by a longitudinal seal so as to form the sleeve-like main portion of the container; and
joining a peripheral edge of said end piece to an upper end of said sleeve-like main portion by a transversal seal extending around said axis.

2. A method as claimed in claim 1, wherein said end piece fully closes the upper end of said sleeve-like main portion, to which it is sealed.

3. A method as claimed in claim 1, wherein said end piece is provided with a neck closed by a removable cap.

4. A method as claimed in claim 3, wherein said neck is closed by a closing wall adapted to be removed in use upon removal of said cap from said neck.

5. A method as claimed in claim 1, wherein, during said step of wrapping, the forming member is rotated about its axis.

6. A method as claimed in claim 1, wherein said end piece is fed to the forming member before said sheet, and wherein said sheet is wrapped around said forming member in such a way that its upper end overlaps said peripheral edge of said end piece.

7. A method as claimed in claim 1, wherein said top portion is made of plastic material and said packaging material of said sheet comprises at least one layer of conductive material and at least one layer of heat-seal plastic material, and wherein at least one of said joining steps is performed by inducing an electric current in said conductive layer of said sheet to heat it locally in the region to be sealed.

8. A method as claimed in claim 1, wherein said forming member receives said end piece and said sheet in a first position, and wherein, after said joining steps, said forming member is axially displaced in a second position, in which it is extracted from said sleeve-like main portion so allowing release of the formed container.

9. A method as claimed in claim 1, wherein one of said side edges of said sheet is provided with a sealing strip adapted to be sealed onto the other side edge during the step of joining for forming the sleeve-like main portion so as to cover said longitudinal seal on the inside of said sleeve-like main portion, and wherein said sheet is advanced towards the forming member with said sealing strip in a forward position.

10. A method as claimed in claim 1, wherein said path has an endless configuration around a further axis parallel to the axis of said forming member, and wherein said step of advancing is performed on a plurality of said forming members distributed around said further axis.

11. A machine for producing a container comprising a sleeve-like main portion and an end piece attached to said main portion, said machine comprising:
at least one forming member having an axis and delimited by a top surface and by a lateral surface extending around said axis;
conveying means for advancing said forming member along given path transversal to said axis;
feeding means for feeding said end piece on said top surface of said forming member;
forming means for wrapping a sheet of packaging material around said lateral surface of said forming member such that the opposite side edges of the sheet parallel to said axis overlap one another;
first sealing means for performing a longitudinal seal along said overlapped edges of said sheet so as to form the sleeve-like main portion of the container; and
second sealing means for performing a transversal seal around said axis to join a peripheral edge of said end piece to an upper end of said sleeve-like main portion.

12. A machine as claimed in claim 11, wherein said forming means comprise an input device for feeding said sheet along a direction transversal to said axis and said path, and first actuator means for rotating said forming member about said axis so as to wrap the sheet fed by said input device around the lateral surface of said forming member.

13. A machine as claimed in claim 12, wherein said input device is arranged downstream of said feeding means along said path.

14. A machine as claimed in claim 11, wherein said forming member is supported by said conveying means in a movable manner along said axis, and wherein the machine further comprises second actuator means for moving said forming member along said axis at least between a first position, in which the forming member can receive said end piece and said sheet, and a second position, in which, after the completion of said container, the forming member is extracted from the sleeve-like main portion.

15. A machine as claimed in claim 14, wherein said forming member is supported, in a sliding and rotating manner with respect to said axis, by a supporting mount carried by said conveying means, and wherein said forming member axially protrudes from said supporting mount in said first position and is completely housed within said supporting mount in said second position so as to permit release of the formed container.

16. A machine as claimed in claim 11 for processing a top portion of plastic material and a sheet of packaging material having at least one layer of conductive material and at least one layer of heat-seal plastic material, wherein at least one of said first and second sealing means comprise an inductor which can be selectively activated for inducing an electric current in said conductive layer of said sheet to heat it locally in the region to be sealed.

17. A machine as claimed in claim 11, wherein said first sealing means are carried by said conveying means and are arranged in front of said forming member, and wherein said second sealing means are carried by said conveying means and are arranged at an upper position than said forming member.

18. A machine as claimed in claim 11, wherein it further comprises third actuator means for moving one of said forming member and said second sealing means along said axis to put said second sealing means into contact with the region to be sealed between said top portion and said sleeve-like main portion.

19. A machine as claimed in claim 11, wherein said conveying means comprise a carousel rotating about a further axis and carrying a plurality of said forming members distributed around said further axis and arranged with their axes parallel to said further axis.

20. A method for producing a sleeve-like element of a multilayer packaging material having at least one layer of conductive material and at least one layer of heat-seal plastic material, said method comprising the steps of:
advancing, along a given path, at least one forming member having an axis transversal to said path, and delimited by a lateral surface extending around said axis;
wrapping a sheet of said multilayer packaging material around said lateral surface of said forming member such that the opposite side edges of the sheet parallel to said axis overlap one another; and
sealing the overlapped edges of the sheet by inducing an electric current in said conductive layer of said sheet to heat it locally in the region to be sealed.

21. A machine for producing a sleeve-like element of a multilayer packaging material having at least one layer of conductive material and at least one layer of heat-seal plastic material, said machine being characterized by comprising:
at least one forming member having an axis and delimited by a lateral surface extending around said axis;
conveying means for advancing said forming member along a given path transversal to said axis;
forming means for wrapping a sheet of said multilayer packaging material around said lateral surface of said forming member such that the opposite side edges of the sheet parallel to said axis overlap one another; and
sealing means for sealing the overlapped edges of the sheet by inducing an electric current in said conductive layer of said sheet to heat it locally in the region to be sealed.
